(19) United States
(12) Patent Application Publication
(10) Pub. No.: US 2008/0071546 A1
(43) Pub. Date: Mar. 20, 2008

(54) SELECTIVE VEHICLE COMPONENT CONTROL

(75) Inventors: Frederick J. Beiermeister, Farmington Hills, MI (US); Christopher L. Oesterling, Troy, MI (US); Jeffrey M. Stefan, Clawson, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 11/948,480

(22) Filed: Nov. 30, 2007

Related U.S. Application Data
(62) Division of application No. 10/607,861, filed on Jun. 27, 2003.

(51) Int. Cl. H04Q 9/00; G10L 11/00

(52) U.S. Cl. 704/273; 340/870.07; 704/275; 704/E15.005

(57) ABSTRACT

The invention provides a system and method for selective vehicle component control. Receiving a speech recognition engine activation signal activates a speech recognition engine in an in-vehicle telematics unit. A voice command is then received at the speech recognition engine of the in-vehicle telematics unit. A vehicle component control command is sent to a control entity from the in-vehicle telematics unit based on the voice command received. Another aspect of the invention provides a computer usable medium that includes a program for selective vehicle component control.

### CROSS-REFERENCE TO RELATED APPLICATION

This application is a divisional of U.S. Ser. No. 10/607,861, filed Jun. 27, 2003, the complete disclosure of which is hereby incorporated by reference.

### FIELD OF THE INVENTION

This invention relates generally to telematics units for mobile vehicles. In particular the invention relates to a system and method for selective vehicle component control.

### BACKGROUND OF THE INVENTION

One of the fastest growing areas of communications technology is related to automobile network solutions. The demands and potential for wireless vehicle communication, networking and diagnostic services have escalated in recent years, with projections that by 2006 almost all new American cars will have some level of telematics service. Although many vehicles on the road today have limited wireless communication functions, such as unlocking a door and setting or disabling a car alarm, new vehicles offer additional wireless communication systems that help personalize comfort settings, run maintenance and diagnostic functions, place telephone calls, access call-center information, update controller systems, determine vehicle location, assist in tracking vehicle after a theft of the vehicle and provide other vehicle-related services. Drivers can call telematics call centers to receive navigational, concierge, emergency, and location services, as well as other specialized help such as locating the geographical position of a vehicle when it has been stolen and honking the horn of a vehicle when it cannot be located in a large parking garage.

A common method of vehicle security involves disabling the vehicle ignition, if entry is attempted while the security system is armed. While this method is effective it is limited to disabling ignition. These security systems rely on wireless transmitters to arm and disarm the vehicle and are susceptible to being broken by unauthorized persons. In an example, a person such as a family member has access to a transmitter to disarm the system but may not be authorized to do so.

While disarming vehicle ignition is a primary concern a user may also desire to disable certain components of a vehicle while leaving others active. When leaving a vehicle with a valet, repair shop, detail shop, or other service provider a user cannot secure the vehicle's phone, audio system, navigation system, climate control, email access, or other vehicle functions since the service provider has authorized access to the vehicle. Any vehicle components the owner cannot take with them or lockdown are therefore accessible to the service provider. The owner may also wish to limit access to vehicle components by friends, family members or others with authorized access to the vehicle.

Lost transmitters are a common problem with most current vehicle security systems. Without a transmitter the owner must obtain a replacement to access his vehicle. Usually the owner will have 2 or 3 transmitters in his possession so that he may provide a transmitter to other drivers and retain a spare transmitter. The owner is therefore presented with the additional task of securing spare transmitters.

It is desirable therefore, to provide a system and method for selective vehicle component control, that overcomes the challenges and obstacles described above.

### SUMMARY OF THE INVENTION

The present invention provides a system and method for selective vehicle component control. Receiving a speech recognition engine activation signal activates a speech recognition engine in an in-vehicle telematics unit. A voice command is then received at the speech recognition engine of the in-vehicle telematics unit. A vehicle component control command is sent to a control entity from the in-vehicle telematics unit based on the voice command received. Another aspect of the invention provides a computer usable medium that includes a program for selective vehicle component control.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for selective vehicle component control in accordance with one embodiment of the current invention.

FIG. 2 is a flow diagram of a method for selective vehicle component control in accordance with one embodiment of the current invention.

FIG. 3 is schematic of the telematics unit of one embodiment of a system for selective vehicle component control, in accordance with the current invention.

### DETAILED DESCRIPTION OF THE PRESENTLY PREFERRED EMBODIMENTS

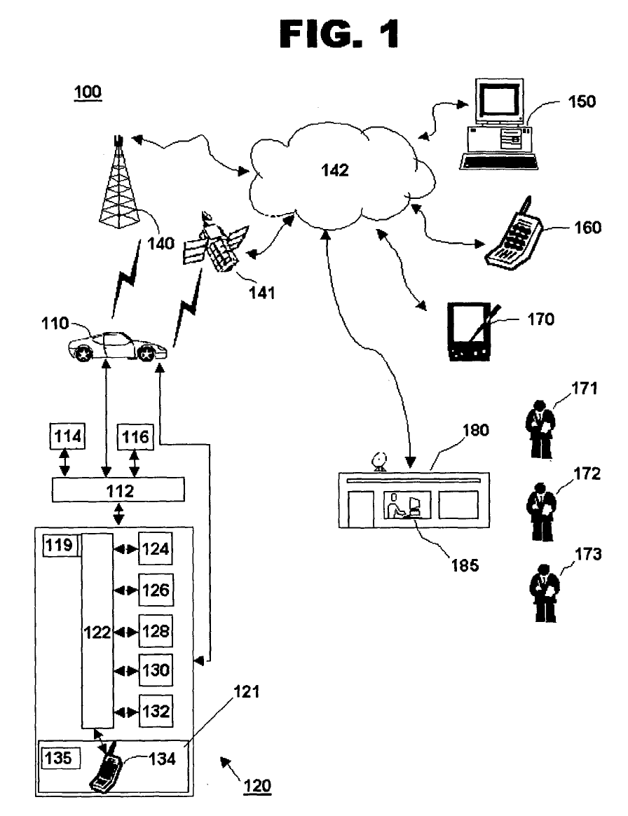

FIG. 1 is a schematic diagram of a system for selective vehicle component control in accordance with one embodiment of the current invention at 100. Selective vehicle component control system 100 includes a mobile vehicle 110, a telematics unit 120, one or more wireless carrier systems 140 or satellite carrier systems 141, one or more communication networks 142, and one or more call centers 180. In one embodiment, mobile vehicle 110 is a vehicle such as a car or truck equipped with suitable hardware and software for transmitting and receiving voice and data communications.

In one embodiment, telematics unit 120 includes a digital signal processor (DSP) 122 connected to a wireless modem 124, a global positioning system (GPS) receiver or GPS unit 126, an in-vehicle memory 128, a microphone 130, one or more speakers 132, an embedded or in-vehicle phone 134 or internet access appliance 135. DSP 122 is also be referred to as a microcontroller, controller, host processor, or vehicle communications processor. In one embodiment, GPS unit 126 provides longitude and latitude coordinates of the vehicle. In-vehicle phone 134 may be an analog, digital, dual-mode, dual-band, multi-mode or multi-band cellular phone.

Telematics unit 120 can store vehicle data upload (VDU) records in in-vehicle memory 128. Telematics unit 120 can set or reset calling-state indicators and can enable or disable various cellular-phone, telematics-unit functions and vehicle components when directed by microcode running on DSP 122. Telematics unit 120 can send and receive over-the-air messages using, for example, a pseudo-standard air-interface function or other proprietary and non-proprietary communication links.

DSP 122 executes various computer programs and computer program code that control programming and operational modes of electronic and mechanical systems within telematics unit 120. In one embodiment, DSP 122 controls communications between telematics unit 120, wireless carrier system 140 or satellite carrier system 141 and call center 180. In one embodiment, a speech recognition application is installed in telematics unit 120 that can translate human voice input through microphone 130 to digital signals. For example, programming of in-vehicle phone 134 is controlled with verbal commands that are translated by speech recognition software executed by DSP 122. Alternatively, pushing buttons on an interface of telematics unit 120 or in-vehicle phone 134 may be used to change a phone number and other phone configuration settings. In one embodiment, the interface to telematics unit 120 includes one or more buttons on the telematics unit, radio console, or associated keyboard or keypad. The interface to telematics unit 120 may include other forms of preference and data entry including touch-screens, wired or wireless keypad remotes, or other wirelessly connected devices such as Bluetooth-enabled devices or 802.11-enabled devices.

DSP 122 controls, generates and accepts digital signals transmitted between telematics unit 120 and a vehicle communication bus 112 that is connected to various vehicle components 114 and sensors 116 in mobile vehicle 110. In one embodiment, DSP 122 activates various programming and operation modes, as well as provides for data transfers. Signals from DSP 122 are, in an example, translated into voice messages and sent out through speaker 132. Generated voice messages include a command prompt, a password prompt or a feedback message notifying user that a command has been executed.

In one embodiment, mobile vehicle 110 via telematics unit 120 sends and receives radio transmissions from wireless carrier system 140, or satellite carrier system 141. Wireless carrier system 140, or satellite carrier system 141 may be any suitable system for transmitting a signal from mobile vehicle 110 to communication network 142.

Communication network 142 includes services from mobile telephone switching offices, wireless networks, public-switched telephone networks, and Internet protocol (IP) networks. Communication network 142 may comprise a wired network, an optical network, a fiber network, another wireless network, or any combination thereof. Communication network 142 connects to mobile vehicle 110 via wireless carrier system 140, or satellite carrier system 141. In one embodiment, communication network 142 connects wireless carrier system 140 or satellite carrier system 141 to user computer 150, cellular phone 160, handheld device, such as personal digital assistant 165, and call center 180. Communication network 142, in one example, sends and receives short messages according to established protocols such as IS-637 standards for short message service (SMS), IS-136 air-interface standards for SMS, and GSM 03.40 and 09.02 standards. Similar to paging, an SMS communication, in such an example, is posted along with an intended recipient, such as a communication device in mobile vehicle 110.

Call center 180 may be a location where many calls may be received and serviced at the same time, or where many calls may be sent at the same time. In one example, the call center 180 is a telematics call center, prescribing communications to and from telematics unit 120 in mobile vehicle 110. In another example, call center 180 is a voice call center, providing verbal communications between an advisor 185 in the call center 180 and a subscriber. In another example, call center 180 contains each of these functions. Call center 180 may receive a telematics unit access request from a telematics user via wireless carrier system 140, satellite carrier system 141, or communication network 142.

Call center 180 provides services to telematics unit 120. Communication services advisor 185 one of a number of support services to a subscriber. Call center 180 may transmit data via data signal, such as a vehicle data upload (VDU), to telematics unit 120 in mobile vehicle 110 through wireless carrier system 140, satellite carrier systems 141, or communication network 142.

Communication services advisor 185 facilitates one of a number of support services to a subscriber. Communication services advisor 185 may be a real advisor or a virtual advisor. A real advisor is a human being in verbal communication with a user or subscriber. In one example, a virtual advisor is a synthesized voice interface responding to requests from telematics unit 120 in mobile vehicle 110. In one example, this virtual advisor includes one or more recorded messages.

Call center 180 can determine mobile identification numbers and telematics unit identifiers associated with a telematics unit access request, compare mobile identification numbers and telematics unit identifiers with a database of identifier records, and send calling-state messages to the telematics unit 120 based on the request and identification numbers.

Mobile vehicle manufacturer 171, mobile vehicle dealer 172, or mobile vehicle owner 173 may have user computer 150 or handheld device 160. In one embodiment, local provisioning system such as user computer 150 or handheld device 160 has a wireless modem to send data through a wireless carrier system 140, or satellite carrier system 141, which connects to communication network 142. Data is received at call center 180. In one embodiment, call Center 180 may have any suitable hardware and software capable of providing web services to help transmit messages and data signals from local provisioning system, such as, user computer 150 or handheld device 160 to telematics unit 120 in mobile vehicle 110. In another embodiment, user computer 150 or handheld device 160 has suitable hardware and software to connect to mobile vehicle 110 using a direct link to a mobile vehicle onboard data port.

In the current embodiment, speech recognition software is installed in telematics unit 120 and is referred to as a speech recognition engine 119. Speech recognition software is executed by DSP 122. In an example, pressing a white button in vehicle 110 activates speech recognition engine 119. In an example, pressing the white button sends a discrete signal that places the telematics unit in audio recognition mode allowing it to respond to voice commands. In another embodiment, pressing a blue button in vehicle 110 initiates communication with call center advisor 185. A voice command is uttered to control a particular vehicle component 114. Speech recognition engine 119 processes the voice command and outputs the proper instructions to the control entity that controls the vehicle component 114. Two classes of components are controlled: telematics components 121 and non-telematics components 114. The telematics components 121 are local to the telematics unit 120 and access to vehicle bus 112 is not required when controlling these components. Examples of telematics components 121 are personal calling access or phone 134 and internet access 135. Control of non-telematics components 114 usually requires access to the vehicle bus 112 for communication with the particular vehicle component's control entity. A control message is placed on vehicle bus 112 directing a particular non-telematics component 114 to function in a particular manner. The control message is received and processed by the vehicle component's control entity. Examples of non-telematics components 114 are the ignition system, the navigation system, the audio system and the climate control system. Telematics unit 120 contains a selection table that is stored in a portion of in-vehicle memory 128. The selection table provides a reference for telematics unit 120 in routing vehicle component control commands to a component's appropriate control entity. Vehicle component control commands are routed either locally to the telematics unit 120 or over vehicle bus 112 to a control entity for a vehicle component 114. Speech recognition engine 119 requires a password to verify authorized access to the selective vehicle component control system. Call center advisor 185 can provide selective vehicle component control service and password-reset service. In one embodiment, the system is configured to send a verification message to a predefined location utilizing communication network 142. If the system is so configured a car rental company or other vehicle owner can maintain a record of each time a component is controlled. For example, a car rental company uses this record to charge a customer for use of the selective vehicle component control service. A vehicle owner can use the record to maintain a log of all access to the system and to receive an alert of any unauthorized attempt to access the system.

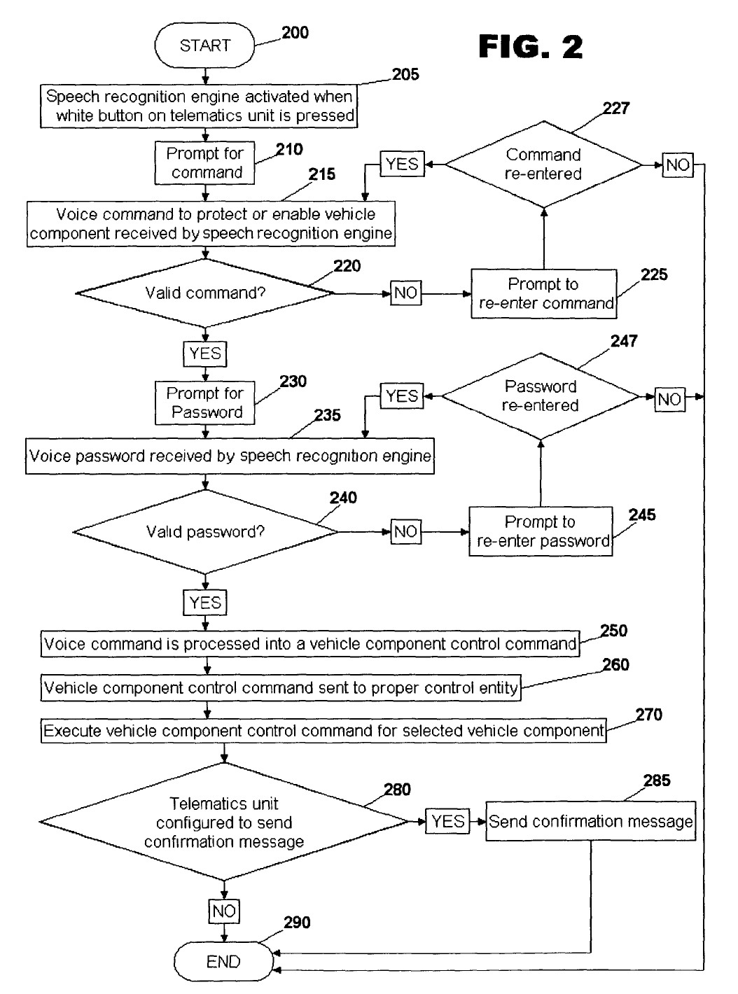

FIG. 2 is a flow diagram of a method for selective vehicle component control in accordance with one embodiment of the current invention. The method for selective control of vehicle components begins 200 when the speech recognition engine of the telematics unit receives an activation signal because the user has pressed the white button on the telematics unit 205. A voice prompt is sent alerting the user that the speech recognition engine is ready to receive a voice command 210. The speech recognition engine receives the uttered voice command 215. The voice command is a command to either protect or to enable a vehicle component. The uttered command may or may not be a valid command 220.

If the speech recognition engine of the telematics unit does not receive a valid voice command a voice prompt is sent alerting the user that the voice command was invalid or not understood and prompting for the command be re-entered 225. The user has the opportunity of retrying the voice command or aborting the selective vehicle component control method 227. If the command is not re-entered, the method ends 290.

If the speech recognition engine of the telematics unit receives a valid voice command, a voice prompt is sent to the user, requesting a voice password 230. The password is used to confirm user is authorized to access the selective vehicle component control functions. The voice password is typically a four-digit number, but may also be an alias or name-tag assigned by the user. The speech recognition engine receives the uttered voice password 235 which may or may not be a valid voice password 240.

If the speech recognition engine of the telematics unit does not receive a valid voice password, a voice prompt is sent alerting the user that the password was invalid or not understood and asking the user to re-enter the password 245. The user has the opportunity to retry uttering the voice password or aborting the vehicle selective component control method 247. In one embodiment, the user is able to contact a call center advisor and request a password reset. If the user does not re-enter the password, the method ends 295

If the speech recognition engine receives a valid password the voice command is processed into a vehicle component control command 250 and the vehicle component control command is routed to the proper control entity 260. The vehicle component control command is then executed by the control entity 270, protecting or enabling the desired component. In one embodiment, the telematics unit is configured to send a confirmation message 280. The confirmation message provides data regarding the use of the selective vehicle component control system and method. If the telematics unit is not configured to send a confirmation message the method ends 290. If the telematics unit is configured to send a confirmation message, the message is sent 285, and the method ends 290.

A simple context-free grammar is used within the speech recognition engine. This grammar is a set of rules, that specify the required syntax for the voice command, and symbols that provide the building blocks to construct all allowed voice command. This extensible grammar allows addition of new components as necessary. The grammar is:

Start → <noun_phrase> <digit_phrase>
<noun_phrase> → <verb><noun>
<digit_phrase> → ZERO, ONE, . . . , ONE HUNDRED
<verb> → PROTECT, ENABLE
<noun> → PHONE, EMAIL, IGNITION, AUDIO, NAVIGATION,
CLIMATE

The following example illustrates the use of the selective vehicle component control system and method using context-free grammar where personal calling is protected. The user presses the white button and utters “PROTECT PHONE.” The speech recognition system the retrieves the vehicle identification number (VIN) and asks the user for a four character voice password. The user utters the voice password, the voice password is verified, and personal calling is disabled. The password may be an alias or name tag representing the actual four digits of the password. When the user wishes to restore personal calling, the user presses the white button and utters “ENABLE PHONE.” The speech recognition system prompts the user for the voice password, and personal calling is restored when the correct voice password is uttered. If the user cannot remember the voice password, a password reset service is offered. In one example, to reset a voice password, the user presses the blue button on the telematics unit, verifies their identity with an Advisor, and the voice password is reset. The user will enter a new password that is retained by the telematics unit and the call center. In another example, the Advisor also protects or enables the particular vehicle component, in this case personal calling, while resetting the voice password.

In one embodiment, the user specifies a disable command after a specified number of ignition cycles, which is indicated by the <digit_Phrase> production of the context-free grammar. The digit utterance specifies the number of ignition cycles that will occur before the disable command is executed. If a user utters ‘PROTECT PHONE FIVE’ then the personal calling feature will be disabled after five ignition cycles. If a user utters “PROTECT PHONE”, then the lack of a digit phrase utterance causes the personal calling feature to be unconditionally disabled.

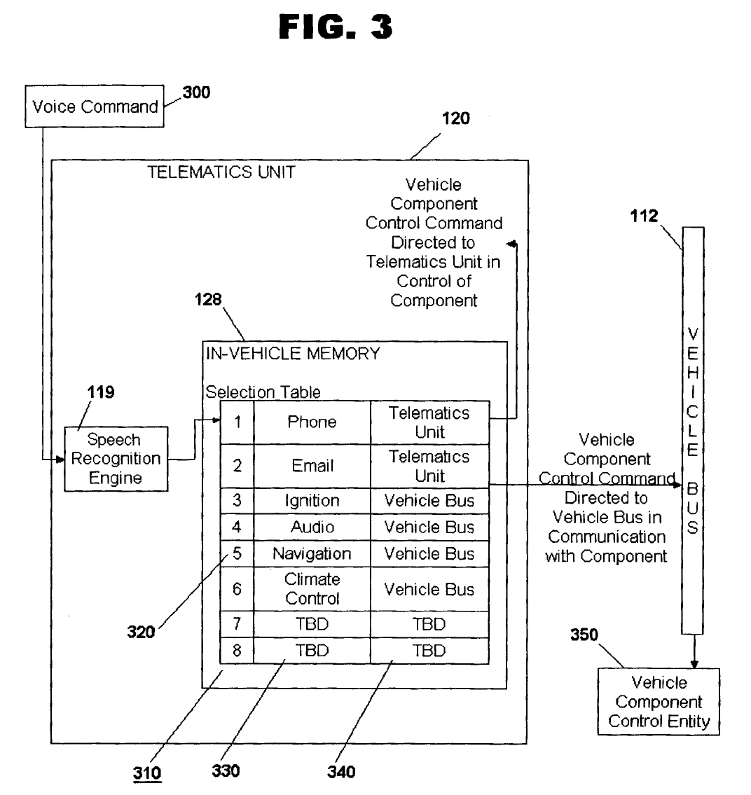

FIG. 3 is schematic of the telematics unit of one embodiment of a system for selective vehicle component control, in accordance with the current invention. The selection table 310 is resident in in-vehicle memory 128 of telematics unit 120. A voice command 300 is processed, by speech recognition engine 119, into a vehicle component control command sent from telematics unit 120. Telematics unit 120 uses selection table 310 to properly route a given command. Each available function is assigned an integer index 320 into the table. The integer index 320 points to a component identifier 330, such as phone, email, ignition, etc. Each component identifier is then associated with a secondary identifier 340 that points to the proper location to route the vehicle component control command. Vehicle component control commands are either directed to the telematics unit 120 in control of the component or to the vehicle bus 112 in communication with the component's control entity 350. For example, the telematics unit controls personal calling features, therefore, commands related to phone function are routed within the telematics unit. Alternately, control of the ignition system requires access to the vehicle bus. Vehicle component control commands relating to the ignition system are routed over the vehicle bus 112 to the powertrain control module (PCM) which controls the functions of the ignition system. Selection table 310 can be edited, as necessary, for the addition or deletion of vehicle components.

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for selective vehicle accessory component control, comprising the steps of:
receiving a voice command to disable one or more features on a vehicle accessory component while leaving the vehicle ignition active, wherein the voice command is received at a speech recognition engine of a vehicle telematics unit;
verifying that the received voice command is a valid voice command; and
disabling the one or more features on the vehicle accessory component in response to the verified voice command such that the one or more features cannot be activated until an enable command is received at the vehicle accessory component.

2. The method of claim 1, further comprising the step of verifying authorization of a user at the speech recognition engine.

3. The method of claim 2, wherein the verifying step further comprises the steps of:
sending a prompt for a voice password;
receiving the voice password at the speech recognition engine;
comparing the received voice password to a password stored at the in-vehicle telematics unit; and
verifying the voice password is valid based on the comparison of the received voice password and the stored password.

4. The method of claim 1, further comprising the step of processing the received voice command into a vehicle accessory component control command, and the disabling step further comprises executing the control command.

5. The method of claim 4, further comprising the step of routing the control command to a control entity for the vehicle accessory component, wherein the control command is executed by the control entity.

6. The method of claim 1, further comprising the step of providing a confirmation message that the one or more features have been disabled.

7. The method of claim 1, further comprising the step of receiving a voice command to disable one or more features on a vehicle accessory component after a specified delay, wherein the disabling step is performed after the specified delay.

8. The method of claim 1, wherein the voice command is interpreted according to a context-free grammar.

9. A method for selective vehicle accessory component control, comprising the steps of:
receiving a voice command at a speech recognition engine of a vehicle telematics unit to enable one or more features on a vehicle accessory component;
verifying that the received command is a valid voice command and verifying that the one or more features of the vehicle accessory component are currently disabled, and, if so,
enabling the one or more features on the vehicle accessory component.

10. The method of claim 9, further comprising the step of verifying authorization of a user at the speech recognition engine.

11. The method of claim 10, wherein the verifying step further comprises the steps of:
sending a prompt for a voice password;
receiving the voice password at the speech recognition engine;
comparing the received voice password to a password stored at the in-vehicle telematics unit; and
verifying the voice password is valid based on the comparison of the received voice password and the stored password.

12. The method of claim 9, further comprising the step of processing the received voice command into a vehicle accessory component control command, and the enabling step further comprises executing the control command.

13. The method of claim 12, further comprising the step of routing the control command to a control entity for the vehicle accessory component, wherein the control command is executed by the control entity.

14. The method of claim 9, further comprising the step of providing a confirmation message that the one or more features have been enabled.

15. The method of claim 9, wherein the voice command is interpreted according to a context-free grammar.

16. A method for selective vehicle accessory component control, comprising the steps of:
receiving a voice command to disable at least one feature on a vehicle accessory component while leaving the vehicle ignition active, wherein the voice command is received at a speech recognition engine of a vehicle telematics unit;
verifying that the voice command was received from an authorized user;
processing the received voice command into a vehicle accessory control command;
routing the vehicle accessory control command to a control entity for the vehicle accessory component based upon a selection table comparison; and
disabling the at least one feature on the vehicle accessory component by executing the vehicle accessory control command, wherein the at least one feature cannot be activated until an enable command is received at the vehicle accessory component.

17. The method of claim 16, wherein the verifying step further comprises the steps of:
sending a prompt for a voice password;
receiving the voice password at the speech recognition engine;
comparing the received voice password to a password stored at the in-vehicle telematics unit; and
verifying the voice password is valid based on the comparison of the received voice password and the stored password.

18. The method of claim 16, wherein the routing step further comprises the steps of:
comparing the vehicle accessory control command to a selection table entry in the vehicle telematics unit;
determining the corresponding control entity for the vehicle accessory component based on the comparison; and
routing the vehicle accessory control command to the corresponding control entity.

19. The method of claim 16, further comprising the step of maintain a log of voice commands received by the speech recognition engine to control vehicle accessory components.

20. The method of claim 16, further comprising alerting a vehicle owner of an unauthorized attempt to control a disabled vehicle accessory component.
